(19) United States
(12) Patent Application Publication
(10) Pub. No.: US 2005/0043091 A1
(43) Pub. Date: Feb. 24, 2005

(54) Apparatus and method for simulating joystick of computer by means of a portable electronic device

(75) Inventor: Szu-Han Wu, Taoyuan City (TW)

Correspondence Address: BACON & THOMAS, PLLC, 625 SLATERS LANE, FOURTH FLOOR, ALEXANDRIA, VA, 22314, US

(73) Assignee: High Tech Computer Corp., Taoyuan City (TW)

(21) Appl. No.: 10/644,849

(22) Filed: Aug. 21, 2003

(51) Int. Cl. A63F 13/00

(52) U.S. Cl. 463/36; 463/47

(57) ABSTRACT

The present invention is to provide a method for simulating a joystick of a computer by means of a portable electronic device, comprising the steps of in response to interconnecting the portable electronic device and the computer and receiving a confirmation instruction for activating a joystick simulation, causing a CPU of the portable electronic device to perform the steps of initializing the communication interface, sending a joystick ID to the computer, and causing the CPU to set a plurality of keys on a keypad of the portable electronic device as a plurality of game keys and a game interrupt key after confirming the computer has received the joystick ID so as to finish task of simulating the portable electronic device as the joystick of the computer.

### FIELD OF THE INVENTION

The present invention relates to portable electronic devices and more particularly to apparatus and method for simulating the joystick of a computer by means of a portable electronic device coupled to the computer.

### BACKGROUND OF THE INVENTION

A conventional smart, portable electronic device such as PDA (Personal Digital Assistant) is designed to be a PIM (Personal Information Management) as a personal schedule manager, notebook, phonebook, or the like. Hence, a PIM is also called as an organizer. Currently, a PDA not only has basic features (e.g., notebook) but also is adapted to integrate voice and wireless transmissions due to the incoming of the age of communication and computer integration. For example, a smart phone having the features of mobile phone and PDA is commercially available. In addition to the basic PIM capability, a smart phone can also connect to the Internet for sending or receiving e-mails, reading news, or downloading files. Further, a smart phone can be used as a mobile communication tool by means of voice. As such, the smart phone has become one of popular electronic products nowadays.

A typical smart, portable electronic device comprises a display, a plurality of keys, and a communication interface (e.g., transmission line or wireless transceiver module) for communicating data with a coupled computer. The smart, portable electronic device can download files or data from the Internet via the coupled computer. Thus, many interesting video games are available for downloading on the Internet. It is also known that the trend of developing electronic products is slimness, compactness, and lightweight in consideration of weight and size. In this regard, the size of display of a smart, portable electronic device is also limited.

Nowadays, still many people think playing video games on a desktop computer or notebook computer can be more fun. However, using a keyboard to play video games may be inconvenient in operation for some video games. The installation of an additional joystick may solve the problem if the cost of buying such joystick is affordable. A most desirable solution as a replacement of the physical joystick is to simulate the joystick of a computer by taking advantage of the well-known smart, portable electronic device.

### SUMMARY OF THE INVENTION

A primary object of the present invention is to provide an apparatus and a method for simulating a joystick of a computer by means of a portable electronic device coupled to the computer. As an end, the portable electronic device is simulated as a joystick of the computer.

One object of the present invention is to provide a method for simulating a joystick of a computer by means of a portable electronic device, comprising the step of in response to interconnecting the portable electronic device and the computer under a current connecting mode and receiving a confirmation instruction for activating a joystick simulation, causing a CPU of the portable electronic device to perform the steps of initializing the communication interface, sending a joystick ID to the computer, and causing the CPU to set a plurality of keys on a keypad of the portable electronic device as a plurality of game keys and a game interrupt key after confirming the computer has received the joystick ID so as to finish task of simulating the portable electronic device as the joystick of the computer. By utilizing the present invention, the cost of buying an additional joystick is saved and the value of the portable electronic device is increased.

The above and other objects, features and advantages of the present invention will become apparent from the following detailed description taken with the accompanying drawings.

### BRIEF DESCRIPTION OF THE DRAWINGS

FIG. 1 schematically shows a block diagram of the invention; and

FIGS. 2 and 3 are flow charts according to a process of the invention.

### DETAILED DESCRIPTION OF THE PREFERRED EMBODIMENTS

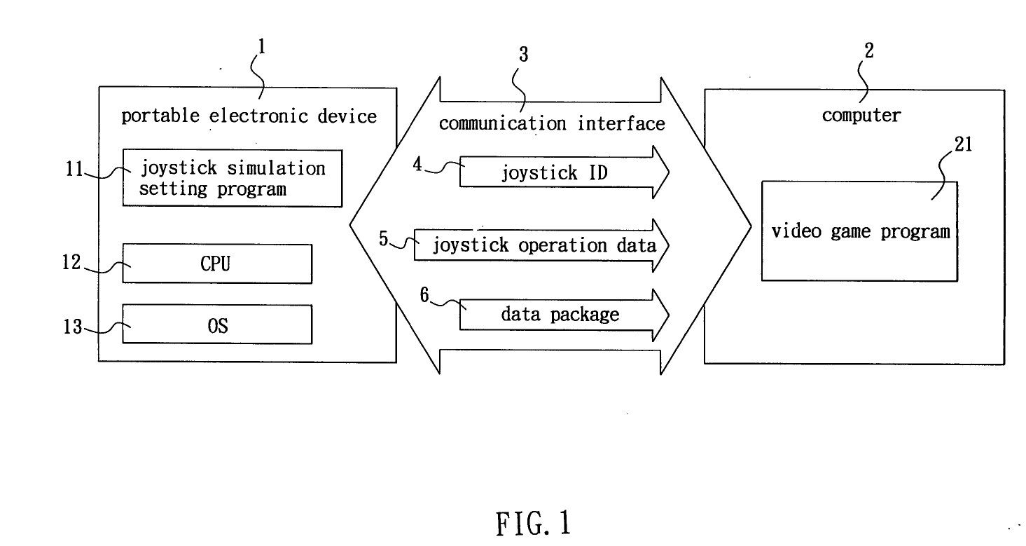

Referring to FIG. 1, an apparatus and a method for simulating a joystick of computer by means of a portable electronic device in accordance with the invention is illustrated. The method comprises installing a joystick simulation setting program 11 in a portable electronic device 1, installing a video game program 21 in a computer 2, responsive to connecting the portable electronic device 1 to the computer 2 via a communication interface 3 and activating the joystick simulation setting program 11 (note that there are many techniques of activating the joystick simulation setting program 11, for example, by clicking a menu option shown on the display of the portable electronic device 1), causing a CPU (central processing unit) 12 of the portable electronic device 1 to determine whether the portable electronic device 1 is connecting to the computer 2 under any of other predetermined connecting modes (i.e., whether the computer 2 and the portable electronic device 1 are communicating data), and in response to the positive determination, terminating the current connecting mode, initializing the communication interface 3 for simulating a joystick, sending a joystick identification (ID) 4 to the computer 2, viewing the portable electronic device 1 as a joystick when the computer 2 has received the joystick ID 4, reading joystick operation data 5 sent from the portable electronic device 1 via the communication interface 3, and causing the CPU 12 to set a plurality of keys on a keypad of the portable electronic device 1 as a plurality of game keys and a game interrupt key.

Thus, the invention is embodied to simulate the portable electronic device 1 as an associated joystick of the computer 2 by allowing a user to customize depending on needs without additional installation of hardware and spending of cost.

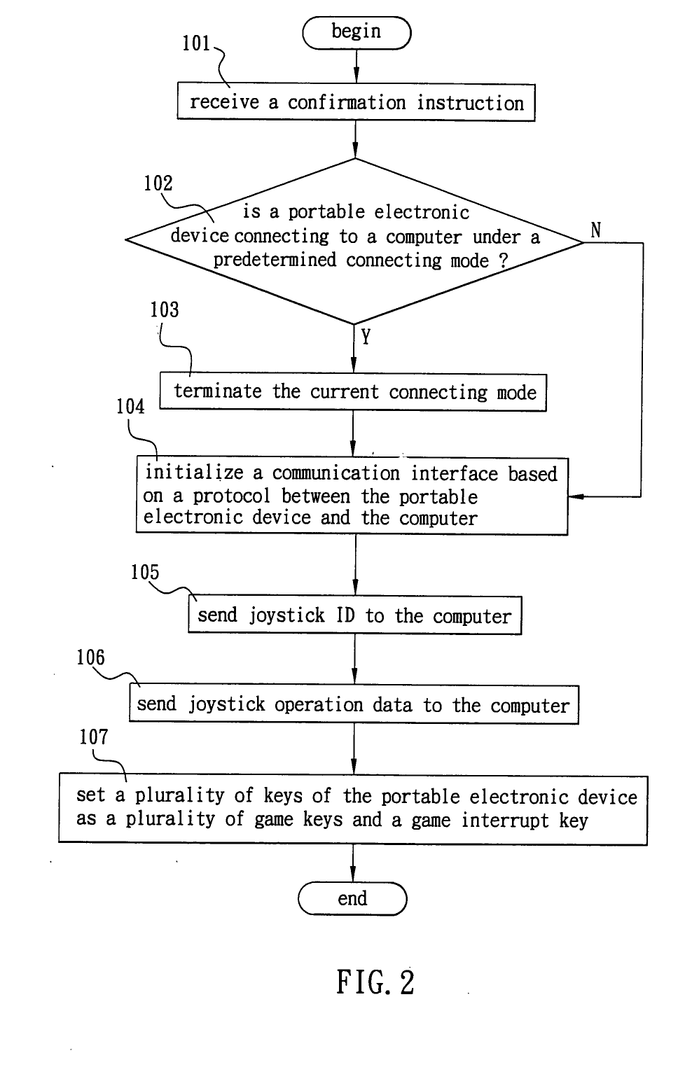

Referring to FIG. 2 in conjunction with FIG. 1, a process of the invention is illustrated. In response to interconnecting the portable electronic device 1 and the computer 2, a user runs the joystick simulation setting program 11 and keys in (or clicks) for executing a confirmation instruction of the joystick simulation setting program 11. Next, a number of following steps are performed by the CPU 12 for determination:

In step 101, receive the confirmation instruction.

In step 102, determine whether the portable electronic device 1 is connecting to the computer 2 under any of other predetermined connecting modes. If yes, the process goes to step 103. Otherwise, the process jumps to step 104.

In step 103, terminate the current connecting mode.

In step 104, initialize the communication interface 3 based on a protocol set up between the portable electronic device 1 and the computer 2.

In step 105, send joystick ID 4 to the computer 2.

In step 106, send joystick operation data 5 to the computer 2.

In step 107, set a plurality of keys on a keypad of the portable electronic device 1 as a plurality of game keys and a game interrupt key.

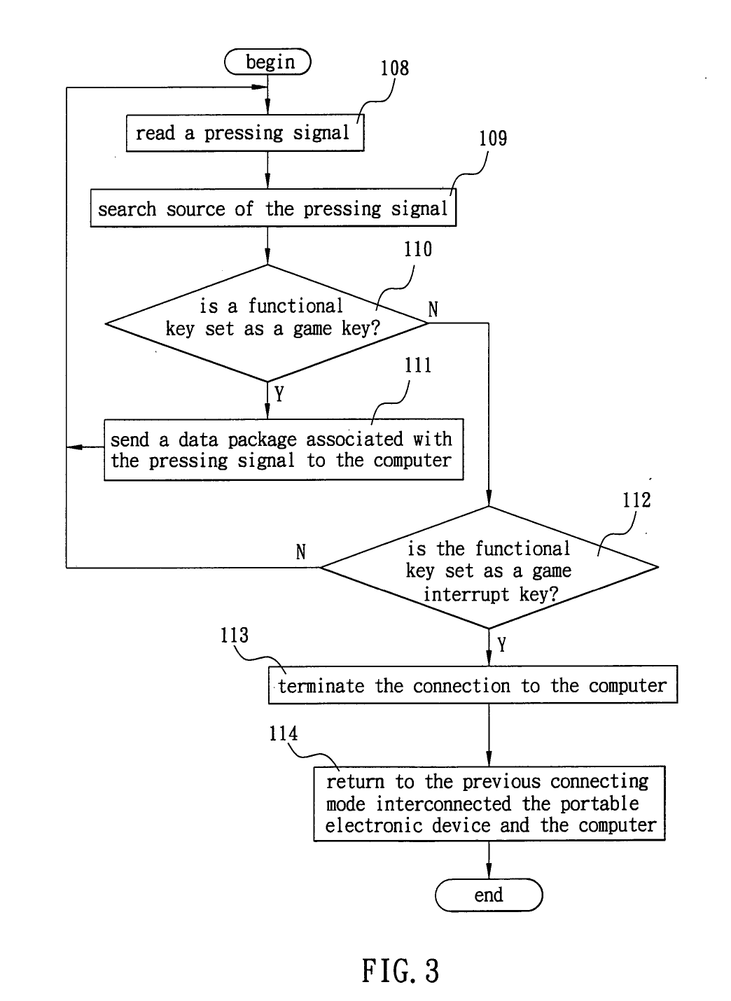

Referring to FIG. 3 in conjunction with FIG. 1, another process of the invention is illustrated. The portable electronic device 1 will be set as an associated joystick of the computer 2 after have completed all steps shown in FIG. 2. However, in a case of not all keys of the keypad of the portable electronic device 1 being set as a plurality of game keys and a game interrupt key, a pressing of a functional key of the keys will issue a pressing signal. Next, the CPU 12 will perform the following steps for determination:

In step 108, read the pressing signal.

In step 109, search source of the pressing signal (i.e., search the functional key).

In step 110, determine whether the functional key has been set as one of a plurality of game keys. If yes, the process goes to step 111. Otherwise, the process jumps to step 112.

In step 111, send a data package 6 associated with the pressing signal to the computer 2 prior to looping back to step 108.

In step 112, determine whether the functional key has been set as a game interrupt key. If yes, the process goes to step 113. Otherwise, the process loops back to step 108.

In step 113, terminate the connection to the computer 2.

In step 114, return to the previous connecting mode interconnected the portable electronic device 1 and the computer 2.

Referring to FIG. 1 again, in the invention in a case of the portable electronic device 1 started to perform the joystick feature, a pressing of the game key will cause the CPU 12 to stop sending the pressing signal to an OS (operating system) 13 of the portable electronic device 1 after the pressing signal has been received by the CPU 12. Instead, the pressing signal is sent to the computer 2 via the communication interface 3, thereby achieving the purpose of simulating a joystick of the computer 2.

Referring to FIG. 1 again, in the invention the portable electronic device 1 is a mobile phone, PDA, or smart phone having the features of mobile phone and PDA.

Referring to FIG. 1 again, in the invention the computer 2 is a desktop computer, notebook computer, or TV game machine.

Referring to FIG. 1 again, in the invention the communication interface 3 is a transmission line such as RS-232 (Recommended Standard 232) stipulated by EIA (Electronics Industries Association) or USB (Universal Serial Bus). Alternatively, the communication interface 3 is a wireless communication element such as Bluetooth or infrared wireless communication module stipulated by IrDA (Infrared Data Association).

Referring to FIG. 1 again, in the invention the CPU 12 will send a data package 6 associated with the game keys to the computer 2 when the game key is pressed. The data package 6 comprises a package ID, a key scan code, and a key state code. As such, the computer 2 will response the video game program 21 and detect the current state of the game keys in response to receiving the data package 6.

While the invention has been described by means of specific embodiments, numerous modifications and variations could be made thereto by those skilled in the art without departing from the scope and spirit of the invention set forth in the claims.

1. A method for simulating a joystick of a computer by means of a portable electronic device, comprising the step of in response to interconnecting the portable electronic device and the computer under a current connecting mode and receiving a confirmation instruction for activating a joystick simulation, causing the portable electronic device to perform the steps of:
determining whether the portable electronic device is connecting to the computer under one of other predetermined connecting modes;
terminating the current connecting mode if the determination is positive;
initializing the communication interface and sending a joystick ID to the computer; and
setting a plurality of keys on a keypad of the portable electronic device as a plurality of game keys and a game interrupt key so as to finish the interconnection between the portable electronic device and the computer and the setting in simulating the portable electronic device as an associated joystick of the computer.

2. The method of claim 1, further comprising the step of initializing the communication interface based on a protocol set up between the portable electronic device and the computer if the determination whether the portable electronic device is connecting to the computer under one of other predetermined connecting modes is negative.

3. The method of claim 2, wherein in response to setting the plurality of keys on the keypad of the portable electronic device as a plurality of game keys and a game interrupt key, a pressing of a functional key of the keys will issue a pressing signal and will cause the portable electronic device to perform the steps of:
reading the pressing signal;
determining a source of the pressing signal;
in response to determining the pressing signal is issued by pressing the functional key, determining whether the functional key has been set as one of the plurality of game keys; and
sending a data package associated with the pressing signal to the computer prior to reading a pressing signal issued by pressing another functional key of the keys if the determination whether the functional key has been set as one of the plurality of game keys is positive.

4. The method of claim 3, further comprising the step of determining whether the functional key has been set as the game interrupt key if the determination whether the functional key has been set as one of the plurality of game keys is negative.

5. The method of claim 4, further comprising the steps of terminating the interconnection between the portable electronic device and the computer and returning to the previous connecting mode interconnected the portable electronic device and the computer if the determination whether the functional key has been set as the game interrupt key is positive.

6. An apparatus for simulating a joystick of a computer, comprising:
a portable electronic device for terminating a predetermined connection to the computer and starting joystick simulation connection and setting in response to receiving a confirmation instruction for activating a joystick simulation; and
a communication interface interconnected the portable electronic device and the computer for communicating signals therebetween,
wherein in response to receiving the confirmation instruction and terminating the interconnection between the portable electronic device and the computer, the portable electronic device initializes the communication interface, sends a joystick ID to the computer, and sets a plurality of keys on a keypad of the portable electronic device as a plurality of game keys and a game interrupt key.

7. The apparatus of claim 6, wherein the portable electronic device is a PDA (Personal Digital Assistant).

8. The apparatus of claim 6, wherein the portable electronic device is a mobile phone.

9. The apparatus of claim 6, wherein the communication interface is a transmission line.

10. The apparatus of claim 6, wherein the communication interface is a wireless communication element.
